(19) United States
(12) Patent Application Publication
(10) Pub. No.: US 2024/0303549 A1
(43) Pub. Date: Sep. 12, 2024

(54) AUTOMATIC ADAPTATION FOR MACHINE LEARNING MODELS

(71) Applicant: OctoML, Inc., Seattle, WA (US)

(72) Inventors: Jason Knight, San Diego, CA (US); Luis Ceze, Seattle, WA (US); Itay Neeman, Seattle, WA (US); Jared Roesch, Seattle, WA (US); Spencer Krum, Minneapolis, MN (US)

(21) Appl. No.: 18/596,437

(22) Filed: Mar. 5, 2024

Related U.S. Application Data
(60) Provisional application No. 63/488,697, filed on Mar. 6, 2023.

(51) Int. Cl. G06N 20/00

(52) U.S. Cl. CPC G06N 20/00

(57) ABSTRACT

A facility for automatically adapting machine learning models for operation or execution on resources is described. The facility receives an indication of a machine learning model and resource constraints for the machine learning model. The facility determines which resources should be allocated for operation of the machine learning model based on the resource constraints and an indication of two or more resources. The facility causes the determined resources to be provisioned for operation of the machine learning model.

### BACKGROUND

Machine learning models are increasingly used to provide artificial intelligence for data analytics, software applications, etc. Each model may run differently on different hardware, such that a model which operates efficiently on a certain device type will require more resources and operate less efficiently on a different device type. Furthermore, the attributes of resources available to run the model, such as the time for the model to generate an inference, the types of hardware available to operate aspects of the model, the cost to use hardware to operate aspects of model, or other resources available to rum the model, may change at any time.

### BRIEF DESCRIPTION OF THE SEVERAL VIEWS OF THE DRAWINGS

FIG. 1 is a block diagram showing some of the components typically incorporated in at least some of the computer systems and other devices on which the facility operates.

FIG. 2 is a display diagram depicting the devices and components which are typically used in a model provisioning network used by the facility in some embodiments.

FIG. 3 is a flow diagram of a process to provision resources for operation of a machine learning model used by the facility in some embodiments.

FIG. 4 is a table diagram of an example resource constraints data table used by the facility in some embodiments.

FIG. 5 is a table diagram of a resource allocation data table used by the facility in some embodiments.

FIG. 6 is a flow diagram of a process to re-provision resources for a machine learning model when the available resources have changed used by the facility in some embodiments.

FIG. 7 is a flow diagram of a process to optimize a machine learning model for operation on changed resources used by the facility in some embodiments.

FIG. 8 is a flow diagram of a process to determine whether inputs for a machine learning model should be batched used by the facility in some embodiments.

FIG. 9 is a flow diagram of a process for determining whether hardware resources can support multiple containers for a machine learning model used by the facility in some embodiments.

FIG. 10 is a table diagram of a sample machine learning model container data table used by the facility in some embodiments.

### DETAILED DESCRIPTION

The inventors have recognized that it would be of great benefit to developers, data scientists, etc., to adapt their machine learning models to be able to optimally operate whenever resources available to run the models change. The inventors have also determined that it would be beneficial to automate the process of provisioning resources to the models as they change.

Developers, data scientists, and other users of machine learning models (collectively “users”) benefit from determining an optimal configuration for the machine learning model that takes into account the resources currently available for use to run the machine learning model. These resources may include one or more of: an amount of time available to generate one or more inferences via the machine learning model; the number of hardware resources available for use by the machine learning model; the type of hardware resources available for use by the machine learning model; the cost to use resources; or other resources which are used to run a machine learning model. Some or all of these resources may be provided by entities other than the user, such as cloud providers or other entities which provide access to hardware resources or computing power for use by machine learning models. Conventionally, users manually determine which resources they are able to use and seek to optimize their machine learning models to operate optimally when executing on the determined resources.

The inventors have recognized a variety of disadvantages with conventional practices to determining optimal configurations of machine learning models. First, a machine learning model that is optimized for a specific set of resources often does not perform as well on another set of resources. Thus, when resource availability changes, such as certain hardware being unavailable, the machine learning model is operated with fewer resources or is operated with resources which the machine learning model is not optimized to use. Second, when the resources available to a machine learning model change, those resources must be manually reallocated to the machine learning model by a user. The manual reallocation of resources typically does not include re-optimization of the machine learning model based on the new set of resources.

In response to recognizing these disadvantages, the inventors have conceived and reduced to practice a software and/or hardware facility for optimizing machine learning models (“the facility”). By identifying an optimal configuration for a machine learning model based on current resource availability, the facility improves the efficiency with which a machine learning model performs its tasks using the resources available. The facility additionally automatically provisions resources for a machine learning model and re-configures the machine learning model to optimally perform with the automatically provisioned resources.

In the present application, references to “optimizing,” “optimization,” “optimize,” etc. means improving or seeking to improve the efficiency of aspects of a machine learning model. As a result, optimization can occur even if the facility fails to identify a more efficient implementation of the machine learning model or of aspects of the machine learning model, or the most efficient possible implementation of the machine learning model or aspects of the machine learning model.

As part of identifying an optimal configuration for a machine learning model based on current resource availability, the facility is able to optimize aspects of the machine learning model for operation with currently available resources. In some embodiments, the facility optimizes these aspects of the machine learning model by altering the machine learning model's implementation, code, executables, parameters, execution plan, or other aspects of the machine learning model to operate more efficiently with the available resources. For example, when a first type of hardware used by the machine learning is not available, but a second type of hardware is available, the facility changes aspects of the machine learning model to improve its operation on the second type of hardware.

The facility uses a controller to provision resources for machine learning models and to ensure that the machine learning models are optimized for the provisioned resources. In some embodiments, at least one machine learning model is hosted on a service which provides resources to the machine learning model. In some embodiments, the facility is installed onto the service, such that it can provision resources to the at least one machine learning model directly from the service.

The facility provisions resources for machine learning models based on resource constraints. In some embodiments, the facility receives the resource constraints via one or more of: user input, programmatic parameters, data resources, or other methods of receiving resource constraints. The resource constraints include one or more of: the cost to use hardware to run the machine learning model, the type of hardware used to run the machine learning model, the availability of hardware used to run the machine learning model, the amount of time that the machine learning model has to generate inferences, and other resource constraints which may affect the performance of a machine learning model. In some embodiments, the facility uses at least one of the resource constraints, an indication of the aspects of the machine learning model, and the type of data consumed by the machine learning model to predict the resource use of the machine learning model. The facility uses the prediction of the resource use of the machine learning model to determine which resources are to be provisioned for the machine learning model.

The facility automatically re-provisions resources for the machine learning model based on the resource constraints when the availability of resources change. The resources are provisioned by using nodes which run a machine learning model, an aspect of a machine learning model, or multiple machine learning models. A node uses all or a portion of the resources available to the machine learning model to run a machine learning model or an aspect of a machine learning model. For example, a node may use an entire hardware component to run an aspect of a machine learning model, or use a portion of the hardware component such that multiple aspects of a machine learning model may independently use the same hardware component simultaneously. In some embodiments, the nodes are containers, such as containers defined via Kubernetes.

As part of provisioning resources for the machine learning model, the facility determines how the machine learning model should be run on the hardware resources available for the machine learning model. In various embodiments, determining how the model should be run includes determining one or more of: whether one or more models should be run on the same instance or node; whether one or more inputs should be batched and transmitted to the model; determining whether the model will be run in multiple threads; whether a mode or configuration setting of the target device or its operating system should be adjusted; or other methods of running or operating a machine learning model. For example, the facility may determine that a single hardware component is able to support multiple instances of the machine learning model. The facility may configure multiple nodes to use the hardware component, and may provision a machine learning model to each node. By operating in this manner, input and output of the machine learning models included in each node are able to stay within the same hardware component, and are able to be used by other nodes hosted on the hardware component without being transmitted to another hardware component or device.

By performing in some or all of the ways described above, the facility is able to quickly and reliably provision resources to machine learning models with limited input and control from users. The facility is also able to improve the efficiency of machine learning models and improve the satisfaction of other constraints or goals for the machine learning model.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by automatically provisioning resources for machine learning models, the facility ensures that the resources used to operate the machine learning model are used in a more optimal manner. Furthermore, by automatically re-provisioning resources, the facility is able to reduce the downtime and excessive use of computing and other resources of machine learning models when the resources available to the machine learning model change.

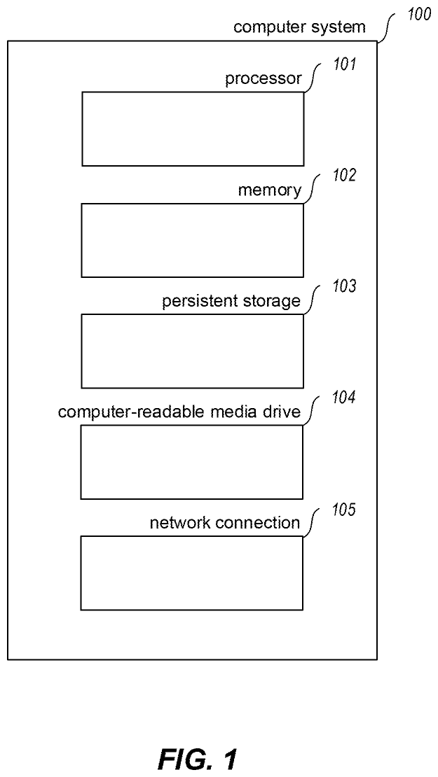

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, Neural Network Accelerator, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

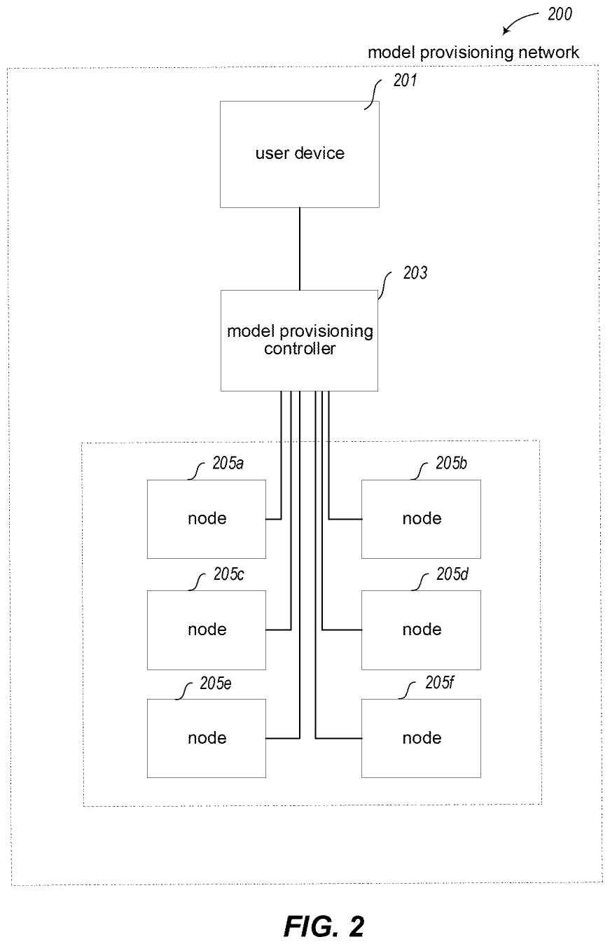

FIG. 2 is a display diagram depicting the devices and components which are typically used in a model provisioning network 200 used by the facility in some embodiments. The model provisioning network 200 includes a user device 201, a model provisioning controller 203, and one or more nodes 205a-205f (collectively “nodes 205”). The model provisioning network 200 is an example of a network of devices used to execute machine learning models. The user device 201 transmits an indication of one or more machine learning models, resource constraints, resource priorities, or other information used to allocate resources for the execution of machine learning models to a model provisioning controller, such as the model provisioning controller 203. In some embodiments, the user device 201 receives data transmitted to the model provisioning controller 203 or nodes 205 via user input.

The facility uses the model provisioning controller 203 to allocate resources to machine learning models, to deploy machine learning models onto resources, to cause the machine learning models to be executed by using allocated resources, to re-allocate resources to machine learning models, or other tasks related to allocating resources for machine learning models. In some embodiments, the model provisioning controller is hosted by one or more of: a user device, such as a user device 201, a service used to provision or allocate resources to machine learning or other software tasks, or another computing device or service which is able to provision resources for performing machine learning or other software tasks. In some embodiments, the facility, such as via the model provisioning controller, generates one or more model containers. A model container includes a machine learning model, a portion of a machine learning model, multiple instances of a machine learning model, or multiple machine learning models. The model container is deployed to a node which is able to execute any portions of machine learning models included in the model container. In some embodiments, the facility generates model containers based on one or more of: a type of the machine learning model portion included in the model container; a purpose of the machine learning model portion included in the model container; a measure of the ability of one or more nodes to host at least a portion of the machine learning model portion included in the model container; whether a model container is to transmit information to another model container; or other factors relevant to generating a model container to be hosted on a node based on resource constraints.

The nodes 205 each have hardware or software components used to host or execute at least a portion of a machine learning model, a model container, or any other aspect or container for executing a machine learning model. The facility may identify the resources available to be provided by each node, such as hardware used by the node, time to generate an inference for a machine learning model portion executed on the node, an ability of the node to host multiple machine learning models, the speed of communication from the node to one or more other nodes, or other resources a node may provide for execution of a machine learning model. The facility may also identify a resource cost for the use of a node, such as a monetary cost to use the node, a loss in the amount of time to generate an inference when using the node, or other costs for using a node to execute a machine learning model.

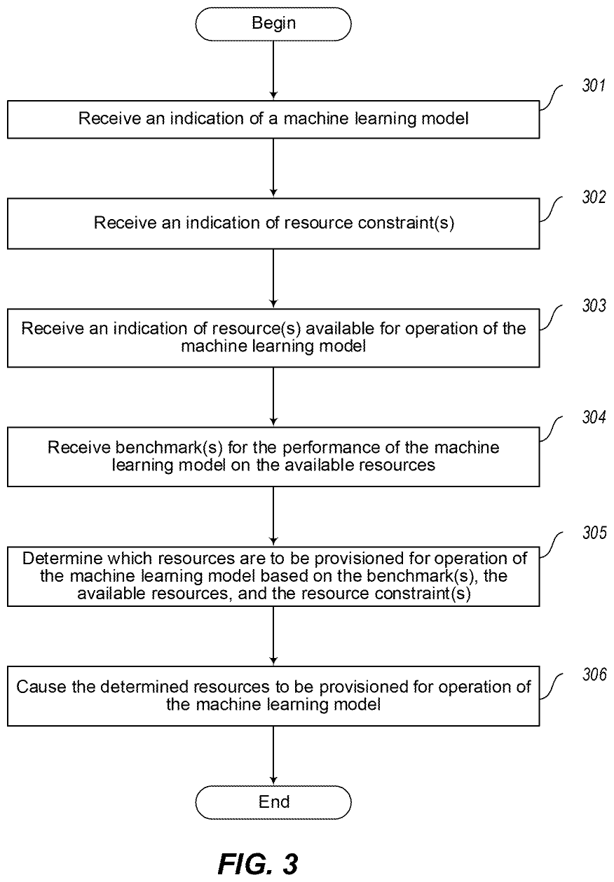

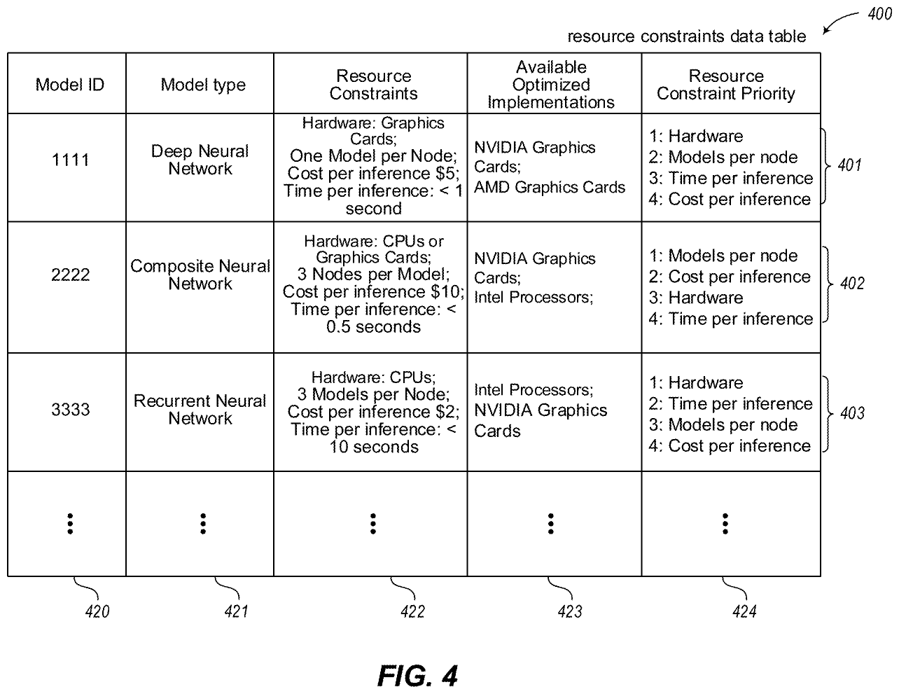

In an example embodiment, a user device causes a model provisioning controller to be deployed to a service which manages a plurality of nodes and other resources for use by machine learning models. The model provisioning controller receives, from the user device, an indication of a target machine learning model, resource priorities, and resource constraints for the target machine learning model. The model provisioning controller identifies the resources available from each node, as well as the resource cost for using each node. The facility, via the model provisioning controller, determines which nodes should be provisioned for execution of the machine learning model based on the resource priorities, resource constraints, target machine learning model, resource cost for each node, and resources available to be provided by each node. The facility may determine which nodes should be provisioned by using one or more of the processes described below in connection with FIGS. 3, 6, 7, 8, and 9, one or more of the data tables described below in connection with FIGS. 4, 5, and 10, or any combination thereof.

Those skilled in the art will appreciate that the acts shown in the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

Furthermore, while the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

FIG. 3 is a flow diagram of a process to provision resources for operation of a machine learning model used by the facility in some embodiments. Resources provisioned for operation of a machine learning model may include one or more of: computing hardware; one or more virtual machines; a cost, such as a cost per inference, a cost for the amount of time resources used, or other costs for operating a machine learning model; an amount of time per inference; or other resources which may be used for operation of a machine learning model. The resources are included in one or more nodes, such as the nodes 205 described above in connection with FIG. 2. First, at act 301, the facility receives an indication of a machine learning model, such as via user input. In some embodiments, the indication of the machine learning model includes one or more of: a type of the machine learning model, one or more weights used by the machine learning model, whether the machine learning model can be split into multiple portions, one or more implementations of a machine learning model optimized for use on certain hardware types, or other information which may be used to indicate or describe a machine learning model.

At act 302, the facility receives an indication of one or more resource constraints, such as via user input. The resource constraints may include an indication of preferred resources for executing the machine learning model, a threshold resource cost for executing the machine learning model, one or more resource priorities, a threshold range for exceeding resource costs, or other resource constraints which may be relevant to the execution of a machine learning model. For example, the resource constraints may indicate that a machine learning model is to be operated by using video cards, at a cost of less than one dollar per inference, and that each inference should be generated within ten seconds. The resource constraints may also indicate that the threshold ranges for exceeding the resource cost of the machine learning model are up to two dollars per inference and up to fifteen seconds to generate an inference. In some embodiments, a threshold range for exceeding resource costs may include a selected period of time, a selected budget, etc., within which the resource costs can be exceeded. Continuing the example, the resource constraints may indicate that the time to generate an inference may exceed ten seconds for a time period of one day and that the cost per inference may exceed one dollar as long as the total additional cost for inferences in an hour do not exceed one hundred dollars. In some embodiments, at act 302, the facility generates or updates a resource constraints data table, such as the example resource constraints data table 400.

FIG. 4 is a table diagram of an example resource constraints data table 400 used by the facility in some embodiments. The resource constraints data table 400 includes data related to resource constraints for allocating resources for the execution of machine learning models. The rows of the resource constraints data table 400 each correspond to a different machine learning model and contains resource constraints specified for executing that machine learning model by the model's owner, or another entity responsible for the model's configuration or execution. The resource constraints data table 400 includes a model id column 420, a model type column 421, a resource constraint column 422, an optimized implementations column 423, and a resource constraint priority column 424.

The model id column 420 includes data indicating an identifier for a machine learning model. The model type column 421 includes data indicating a type of the machine learning model identified by the model id column 420. The resource constraint column 422 includes data indicating one or more resource constraints for the machine learning model identified in the model id column 420. The optimized implementations column 423 includes data indicating one or more optimized implementations of the machine learning model identified in the model id column 420 for operation on certain hardware targets. The resource constraint priority column 424 includes data indicating which resource constraints should be prioritized over other resource constraints.

For example, row 401 indicates that a deep neural network should be executed on a node which uses graphics cards, that one model should be present on the node, that the cost per inference should be $5 or less, and that the time per inference should be less than one second. The row 401 additionally indicates that the facility is able to access an implementation of the deep neural network optimized for NVIDIA graphics cards and an implementation of the deep neural network optimized for AMD graphics cards. The row 401 further indicates that the type of hardware which runs the machine learning model has the highest priority, followed by the number of models running on the node, the time per inference, and finally the cost per inference. Row 402 indicates similar data for a composite neural network which should be allocated three nodes per model. Row 403 indicates similar data for a recurrent neural network which should have three models allocated per node.

Returning to FIG. 3, at act 303, the facility receives an indication of one or more resources available for operation of the machine learning model. In some embodiments, the facility receives the indication of resources available for operation of the machine learning model by identifying one or more nodes which are available for use by the machine learning model. In some embodiments, for each identified node, the facility receives an indication of the resources associated with the node and the cost to use the associated resources.

At act 304, the facility receives one or more benchmarks for the performance of the machine learning model on the available resources. In some embodiments, the benchmarks include one or more of: an amount of time for the machine learning model to produce an inference with the available resources, an amount of time for one or more portions of a machine learning model to execute on the available resources, an amount of time for data generated by the machine learning model to be transferred from the node to another node or computing device, a cost to produce one or more inferences via the machine learning model with the available resources, or other indicators of the performance, resource usage, or resource cost of the operation of a machine learning model with available resources. In some embodiments, the facility receives the benchmarks via one or more of: generating the benchmarks, such as by utilizing available nodes to determine benchmarks for machine learning models; accessing a repository of benchmarks already generated for the machine learning model; accessing a repository of benchmarks generated for machine learning models of a similar type to the machine learning model; estimating the benchmarks based on benchmarks, optimization data, or any combination thereof for similar machine learning models; accessing optimization data generated when optimizing the machine learning model or similar machine learning models; or any other method of determining benchmarks representing the performance, resource usage, or resource cost of the operation of a machine learning model with available resources.

At act 305, the facility determines which resources are to be provisioned for operation of the machine learning model based on the one or more benchmarks, the one or more available resources, and the one or more resources constraints. In some embodiments, the facility determines which resources should be provisioned for operation of the machine learning model by procedurally determining which resources can be provisioned for operation of the machine learning while maintaining the specified resource constraints. In some embodiments, if the facility is unable to meet the specified resources constraints, the facility prioritizes resources based on one or more of: resource priorities and a threshold range for exceeding any resource costs included in the resource constraints. For example, the resource constraints may specify that a model should run on a node which costs one dollar per inference, and which takes less than one second to produce an inference. If such a node is not available, the facility may use resource priorities to choose between two nodes, the first of which costing one dollar and two seconds per inference and the second of which costing two dollars and one second per inference. If the facility is to prioritize cost over time then it would choose the first node, and if the facility is to prioritize time over cost it would choose the second node.

In some embodiments, the facility may provision multiple differing types of nodes to meet resource constraints. Continuing the above example, if the user requires two machine learning models each operating on separate nodes, and a third node costs one dollar and one second per inference is available, the facility may determine that the third node should be provisioned for one of the machine learning models, and the first or second node be provisioned for the other machine learning model.

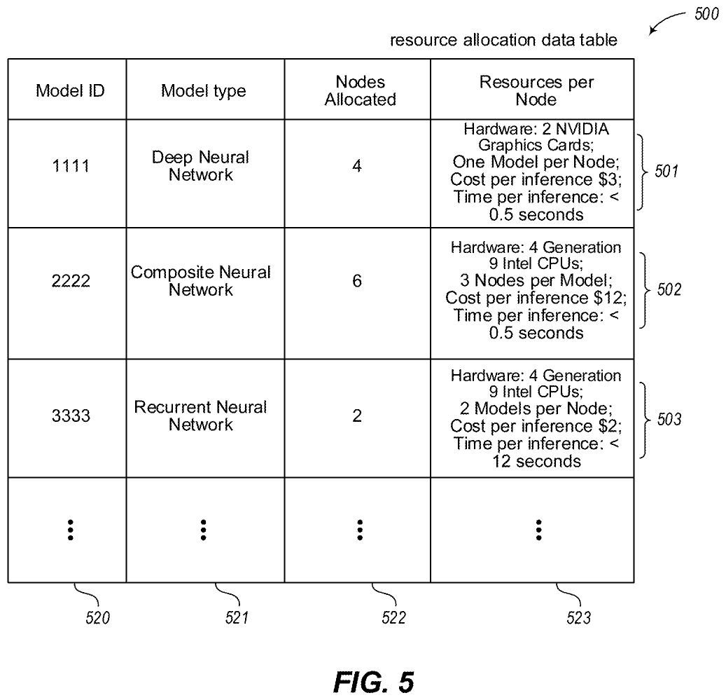

At act 306, the facility causes the determined resources to be provisioned for operation of the machine learning model. In some embodiments, the facility causes the determined resources to be provisioned by one or more of: causing one or more nodes associated with the determined resources to be reserved for use by the machine learning model; transmitting one or more model containers each including at least a portion of the machine learning model to one or more nodes associated with the determined resources; or any other action which may cause resources to be provisioned for use by a machine learning model. In some embodiments, at act 306, the facility causes one or more nodes associated with the determined resources to execute at least a portion of a machine learning model. In such embodiments, the facility may cause the one or more nodes to execute the portion of the machine learning model by transmitting one or more inputs for the machine learning model to the one or more nodes. In some embodiments, while performing act 306, the facility generates, updates, or otherwise uses a resource allocation data table, such as the resource allocation data table 500 described below in connection with FIG. 5.

FIG. 5 is a table diagram of a resource allocation data table 500 used by the facility in some embodiments. The resource allocation table 500 may be generated by the facility as a result of the process described above in connection with FIG. 3, and may include data regarding resources and nodes which are provisioned for the operation or execution of machine learning models. The rows of the resource allocation data table 500 each correspond to a different machine learning model and contains information specifying resources allocated for operation or execution of the machine learning model. The resource allocation data table 500 includes a model id column 520, a model type column 521, an allocated nodes column 522, and a resources per node column 523. The model id column 520 and model type column 521 may be similar to the model id column 420 and model type column 421, respectively, described above in connection with FIG. 4.

The allocated nodes column 522 includes data indicating the number of nodes provisioned for the machine learning model identified in the model id column 520. In some embodiments, the allocated nodes column 522 includes data indicating which nodes are provisioned for the machine learning model, such as by including one or more identifiers for the provisioned nodes.

The resources per node column 523 includes data indicating the resources associated with each node specified in the allocated nodes column 522. In embodiments where different types of nodes are provisioned for the machine learning model, the resources per node column 523 includes data indicating the resources associated for each type of node allocated for the machine learning model. For example, a first instance of a machine learning model may be assigned to a first node which includes NVIDIA graphics cards and a second instance of the machine learning model may be assigned to a second node which includes AMD graphics cards. The resources per node column 523 may then include data indicating the hardware of the first node and the second node. In some embodiments, instead of including the data for both of the nodes in a single row, the resource allocation data table 500 includes a row for each instance of the machine learning model and which each include data describing the nodes provisioned for the respective instance of the machine learning model.

Row 501 indicates that four nodes are provisioned for a deep neural network, and that each node includes 2 NVIDIA graphics cards, that each of the four nodes hosts one instance of the deep neural network, that the cost per inference is three dollars, and that the time per inference is half a second. Row 502 indicates that six nodes are provisioned for a composite neural network, and that each node includes four Intel processors, that three nodes are provisioned for each instance of the composite neural network, that the cost per inference is twelve dollars, and that the time per inference is half a second. Row 503 indicates that two nodes are provisioned for a recurrent neural network, that each node includes four Intel processors, that each node hosts two instances of the recurrent neural network, that the cost per inference is two dollars, and that the time per inference is twelve seconds.

Returning to FIG. 3, after act 306, the process to provision resources for operation of a machine learning model ends.

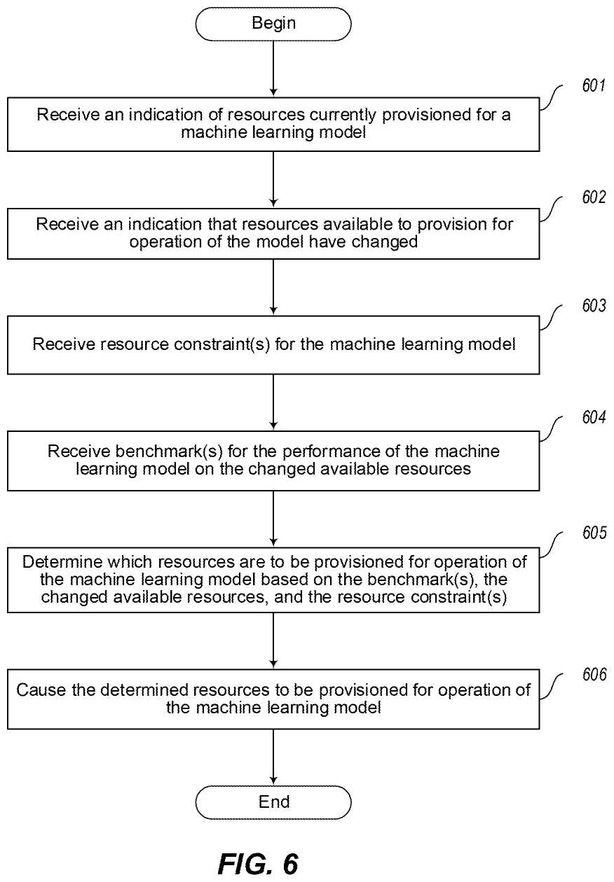

FIG. 6 is a flow diagram of a process to re-provision resources for a machine learning model when the available resources have changed used by the facility in some embodiments. First at act 601, the facility receives an indication of resources currently provisioned for a machine learning model. In some embodiments, the facility performs act 601 by accessing a data table describing how resources are provisioned for machine learning models, such as the resource allocation data table 500 described above in connection with FIG. 5.

At act 602, the facility receives an indication that resources available to provision for the operation of the machine learning model have changed. In some embodiments, at act 602, the facility receives an indication that resource constraints for the machine learning model have changed. In some embodiments, the facility receives the indication that the available resources have changed via a service hosting one or more nodes associated with the resources, user input, or other methods of determining whether resources available to provision for operation of a machine learning model have changed. In some embodiments, the facility receives an indication of the available resources periodically, in “real-time,” or at any other frequency usable to monitor a change in available resources for a machine learning model.

At act 603, the facility receives one or more resource constraints for the machine learning model. In some embodiments, the facility performs act 603 in a similar manner to act 302. In some embodiments, the resources constraints received in act 603 are different resource constraints than those received to provision the currently provisioned resources for the machine learning model.

At act 604, the facility receives one or more benchmarks for the performance of the machine learning model on the changed available resources. In some embodiments, the facility performs act 604 in a similar manner to act 304.

At act 605, the facility determines which resources are to be provisioned for operation of the machine learning model based on the one or more benchmarks, the changed available resources, and the one or more resource constraints. In some embodiments, the facility performs act 605 in a similar manner to act 305.

At act 606, the facility causes the determined resources to be provisioned for operation of the machine learning model. In some embodiments, the facility performs act 606 in a similar manner to act 306.

After act 606, the process to re-provision resources ends. In some embodiments, when a portion of the resources available to operate the machine learning model change, the facility only re-provisions the machine learning models associated with nodes whose resources have changed. For example, if three machine learning models are each provisioned to a node, and the resources for a first node of the three nodes changes the facility re-provisions the machine learning model associated with the first node, but not the machine learning model associated with the other two nodes.

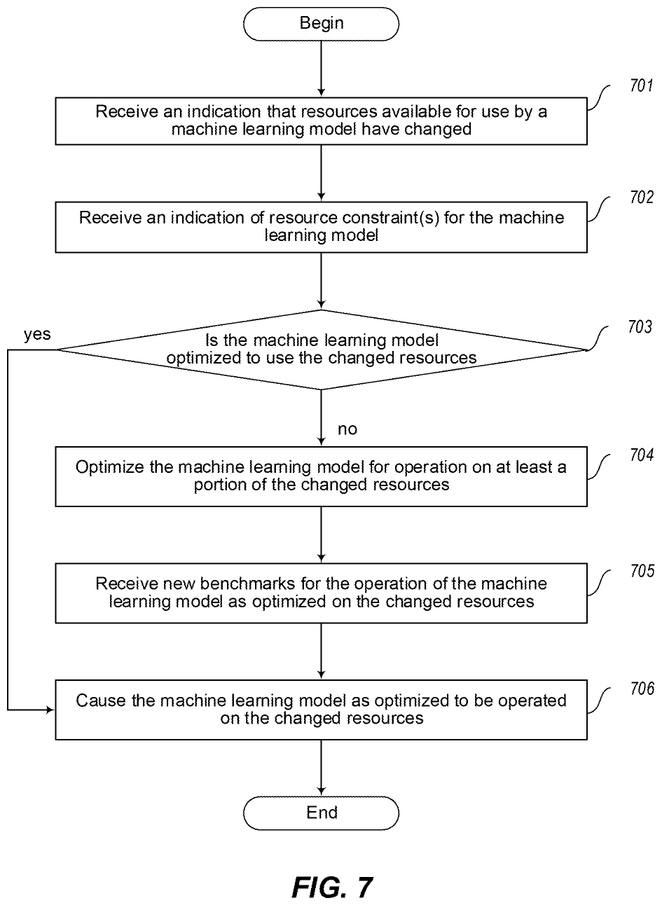

FIG. 7 is a flow diagram of a process to optimize a machine learning model for operation on changed resources used by the facility in some embodiments. First, at act 701, the facility receives an indication that resources available for use by a machine learning model have changed. In some embodiments, the facility performs act 701 in a similar manner to act 601.

Next, at act 702, the facility receives an indication of resource constraints for the machine learning model learning model. In some embodiments, the facility performs act 702 in a similar manner to act 603.

Next, at act 703, the facility determines whether the machine learning model is optimized to use the changed resources. In some embodiments, the facility determines whether the machine learning model is optimized to use the changed resources based on one or more of: whether an optimized implementation of the machine learning model for operation with the changed resources has been generated, the similarity of the resources for which the machine learning model is currently optimized to the changed resources, or other indicators of whether a machine learning model is optimized for operation with resources.

If the facility determines that the machine learning model is optimized to use the hanged resources, the facility continues to act 706, otherwise the facility continues to act 704.

At act 704, the facility optimizes the machine learning model for operation on at least a portion of the changed resources. In some embodiments, the facility optimizes the machine learning model by: altering one or more weights used by the machine learning model, altering one or more code portions which make up the machine learning model, other methods of optimizing a machine learning model, or any combination thereof. In some embodiments, the facility optimizes a machine learning model based on one or more of: operational benchmarks of at least a portion of the machine learning model, optimization data from obtained by optimizing machine learning models for operation with resources similar to the changed resources, and other data used to optimize machine learning models.

At act 705, the facility receives new benchmarks for the operation of the optimized version of the machine learning model on the changed resources. In some embodiments, the facility performs act 705 in a similar manner to act 304.

At act 706, the facility causes the machine learning model as optimized to be operated on the changed resources. In some embodiments, the facility performs act 706 in a similar manner to act 306.

After act 706, the process to optimize a machine learning model for operation on changed resources ends. In some embodiments, when a first portion of the optimized machine learning model operates more optimally on hardware than a second portion of the optimized machine learning model, the facility may cause different hardware or nodes to be provisioned for the first and second portions of the machine learning model. For example, if a first portion of the machine learning model operates more optimally on a processor and a second portion operates more optimally on a graphics card, the facility provisions a node which includes a processor for operation of the first portion and a node which includes a graphics card for operation of the second portion.

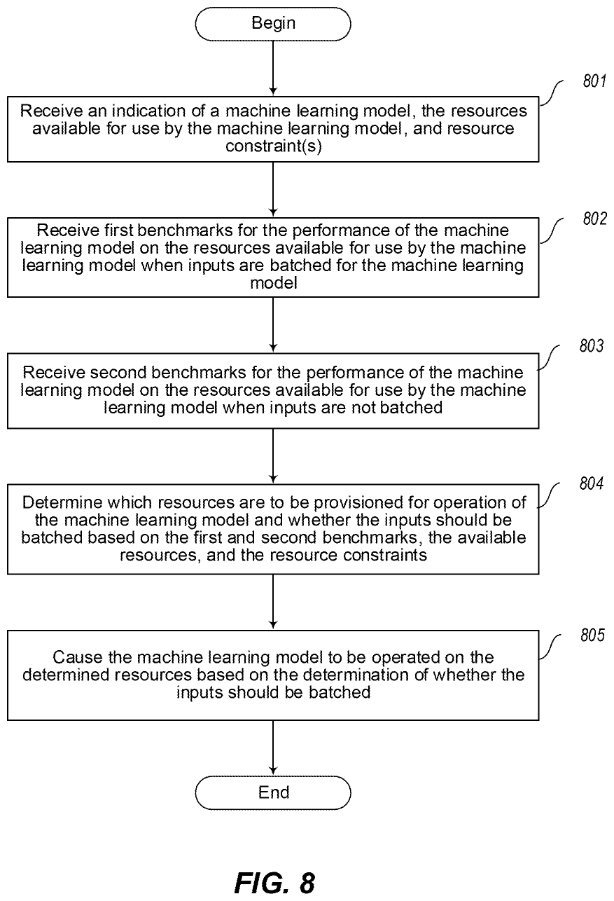

FIG. 8 is a flow diagram of a process to determine whether inputs for a machine learning model should be batched used by the facility in some embodiments. First, at act 801, the facility receives an indication of a machine learning model, the resources available for use by the machine learning model, and resource constraints. In some embodiments, the facility performs act 801 in a similar manner to one or more of acts 301, 302, and 303.

At act 802, the facility receives a first set of benchmarks for the performance of the machine learning model on the resources available for use by the machine learning model when inputs are batched for the machine learning model. In some embodiments, batching inputs includes one or more of: batching the inputs before they are received by one or more nodes upon which the machine learning model operates, batching inputs on a node which communicates with one or more nodes upon which the machine learning model operates, batching inputs on one or more nodes upon which the machine learning model operates, batching a portion of the inputs, and any other method of batching inputs for a machine learning model.

At act 803, the facility receives a second set of benchmarks for the performance of the machine learning model on the resources available for use by the machine learning model when inputs are not batched. In some embodiments, the facility performs acts 802 and 803 in a similar manner to act 304.

At act 804, the facility determines which resources are to be provisioned for operation of the machine learning model and whether the inputs should be batched based on the first and second sets of benchmarks, the available resources, and the resource constraints. In some embodiments, the facility performs act 804 in a similar manner to act 305. In some embodiments, the facility determines which nodes should be provisioned for use by the machine learning model based on the determination of whether inputs should be batched and the determination of how the inputs should be batched. For example, if it is determined that operation of the machine learning model improves when a separate node than the node hosting the machine learning model batches the inputs, the facility may allocate nodes which are physically closer to each other to batch the inputs and execute the machine learning model. In another example, the facility may determine that a single node may be able to batch inputs and support operation of the machine learning model while still operating within the resource constraints. In such an example, the facility causes the node to batch the inputs to ensure that the node does not need to transmit the batched inputs to another node in order for the inputs to be applied to the machine learning model.

At act 805, the facility causes the machine learning model to be operated on the determined resource based on the determination of whether the inputs should be batched. In some embodiments, the facility performs act 805 in a similar manner to act 706.

After act 805, the process to determine whether inputs for a machine learning model should be batched ends.

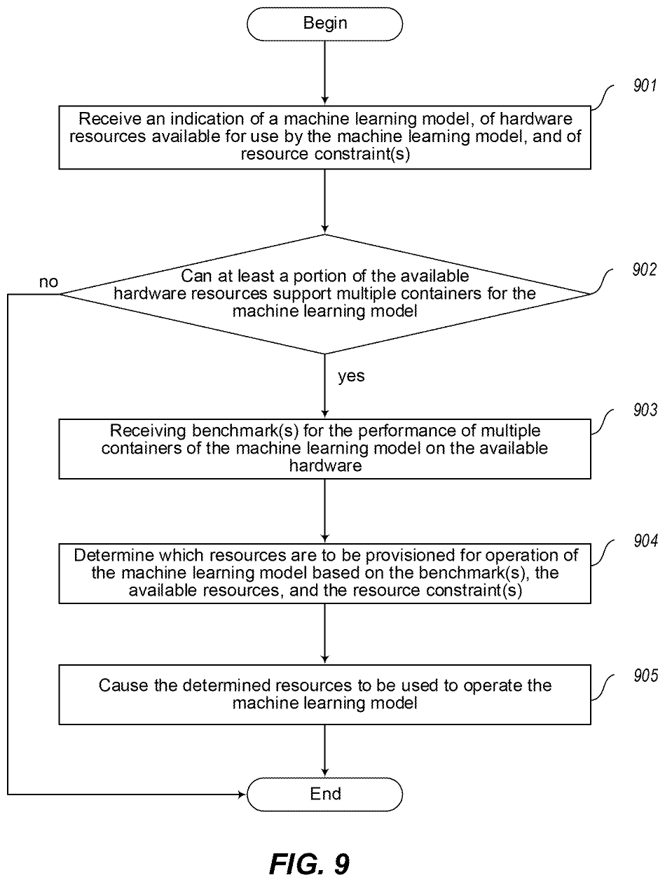

FIG. 9 is a flow diagram of a process for determining whether hardware resources can support multiple containers for a machine learning model used by the facility in some embodiments. First, at act 901, the facility receives an indication of a machine learning model, hardware resources available for use by the machine learning model, and resource constraints. In some embodiments, the facility performs act 901 in a similar manner to act 801.

At act 902, the facility determines whether at least a portion of the available hardware resources associated with one or more nodes can support multiple containers for the machine learning model. In some embodiments, the facility performs act 902 based on one or more of: the effect of splitting machine learning model into multiple portions, the size of the machine learning model, the ability of hardware resources to perform parallel processing or multi-threaded processing tasks, and other factors related to whether hardware resources associated with one or more nodes can support multiple containers for the machine learning model.

If the facility determines that none of the available hardware resources are able to support multiple model containers, the process for determining whether hardware resources can support multiple containers for a machine learning model ends, otherwise, the process proceeds to act 903.

At act 903, the facility receives benchmarks for the performance of multiple model containers on the available hardware. The benchmarks received in act 903 include one or more of: the effect of running multiple machine learning models on the hardware, the effect of the performance of the machine learning model when multiple instances of the machine learning model run on the available hardware, and other benchmarks related to the performance of multiple model containers on the available hardware. In some embodiments, the facility performs act 903 in a similar manner to act 304.

At act 904, the facility determines which resources are to be provisioned for operation of the machine learning model based on the benchmarks, the available resources, and the resource constraints. In some embodiments, the facility performs act 904 in a similar manner to act 305.

At act 905, the facility causes the determined resources to be used to operate the machine learning model. In some embodiments, the facility performs act 905 in a similar manner to act 306.

After act 905, the process for determining whether hardware resources can support multiple containers for a machine learning model ends.

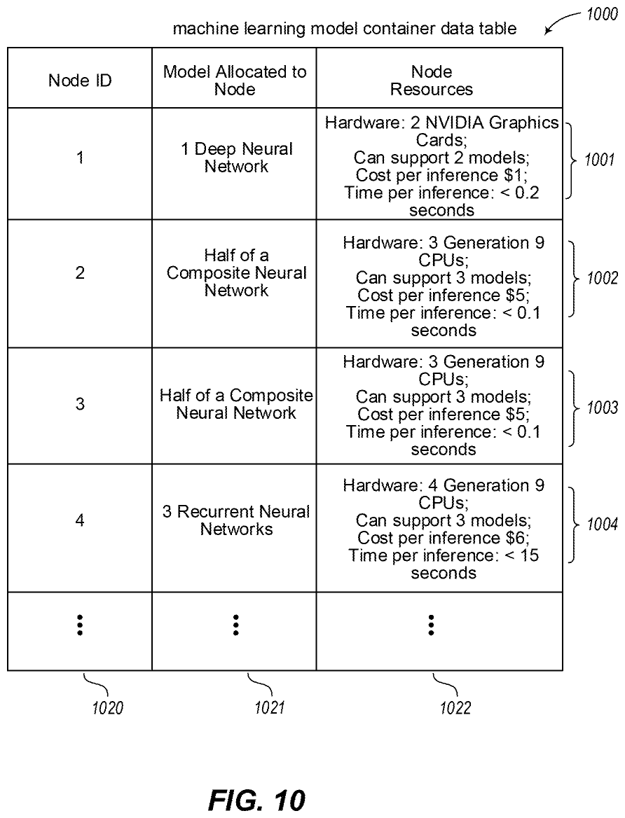

FIG. 10 is a table diagram of a sample machine learning model container data table 1000 used by the facility in some embodiments. The machine learning model container data table 1000 incudes data related to nodes upon which machine learning models are operated. The rows of the machine learning model container data table 1000 each correspond to a different container which includes at least a portion of a machine learning model and contains data indicating the resources allocated to the container for executing or operating the portion of the machine learning model. The machine learning model data table 1000 includes a node id column 1020, a model allocation column 1021, and a node resources column 1022.

The node id column 1020 includes data indicating an identifier for a node. The model allocation column 1021 includes data indicating a machine learning model, a machine learning model portion, multiple machine learning models, or any combination thereof, which are provisioned for operation on the node specified by the node id column 1020. The node resources column 1022 includes data indicating the resources provided by the node.

For example, row 1001 indicates that a deep neural network is allocated to node one and that node one includes two graphics cards, can support two models, and costs one dollar and one-fifth of a second per inference. Rows 1002 and 1003 each indicate one half of a composite neural network operates on node two and another half of a composite neural network operates on node three. Row 1004 indicates that three recurrent neural network operate on node four.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. One or more instances of computer-readable media collectively having contents configured to cause a computing device to perform a method for provisioning machine
learning model resources, the method comprising:
receiving an indication of a machine learning model;
receiving an indication of one or more resource constraints;
receiving an indication of two or more resources available for operation of the machine learning model;
determining which resources of the two or more resources are to be provisioned for operation of the machine learning model based on the one or more resource constraints and the indication of two or more resources; and
causing the determined resources to be provisioned for operation of the machine learning model.

2. The one or more instances of computer-readable media of claim 1, wherein the method for provisioning machine learning model resources further comprises:
determining whether the machine learning model is optimized for operation with at least a portion of the determined resources; and
based on the determining, optimizing the machine learning model for operation with the portion of the determined resources.

3. The one or more instances of computer-readable media of claim 1, wherein the method for provisioning machine learning model resources further comprises:
receiving an indication that at least a portion of the two or more resources available for operation of the machine learning model have changed;
determining which new resources of the two or more changed resources are to be provisioned for operation of the machine learning model based on the or more resource constraints and the indication of the changed two or more resources; and
causing the new resources to be provisioned for operation of the machine learning model.

4. The one or more instances of computer-readable media of claim 3, wherein causing the new resources to be provisioned for operation of the machine learning model further comprises:
optimizing the machine learning model for operation with the new resources.

5. The one or more instances of computer-readable media of claim 3, wherein the indication that at least a portion of the two or more resources have changed comprises one or more of:
an indication that at least a portion of the one or more resource constraints have changed;
an indication that software used to determine which resources are to be provisioned for operation of the machine learning model have changed; and
an indication that at least one aspect of the two or more resources available for operation of the machine learning model have changed.

6. The one or more instances of computer-readable media of claim 1, wherein determining which resources of the two or more resources are to be provisioned for operation of the machine learning model further comprises:
for each respective resource of the two or more resources:
determining whether inputs to the machine learning model can be batched while the respective resource is being used for operation of the machine learning model based on the machine learning model, the respective resource, and the resource constraints; and
determining which resources of the two or more resources are to be provisioned for operation of the machine learning model based on the one or more resource constraints, the indication of two or more resources, and the determinations of whether inputs to the machine learning model can be batched.

7. The one or more instances of computer-readable media of claim 1, wherein determining which resources of the two or more resources are to be provisioned for operation of the machine learning model further comprises:
identifying a plurality of nodes based on the determined resources, each node including at least a portion of the determined resources;
generating a plurality of model containers based on the determined resources and the plurality of nodes, each model container including at least a portion of the machine learning model; and
for each respective node of the plurality of nodes:
causing at least one model container of the plurality of model containers to be deployed to the respective node.

8. The one or more instances of computer-readable media of claim 7, wherein determining which resources of the two or more resources are to be provisioned for operation of the machine learning model further comprises:
for each respective resource of the two or more resources:
determining whether the extent to which the operation of the machine learning model utilizes the respective resource based on the machine learning model and the resource constraints; and
based on the determined extent to which the machine learning model utilizes the respective resource, determining whether the multiple model containers are able to use the respective resource at the same time; and
determining which resources of the two or more resources are to be provisioned for operation of the machine learning model based on the one or more resource constraints, the indication of two or more resources, and the determinations of whether multiple model containers are able to use each resource of the two or more resources.

9. The one or more instances of computer-readable media of claim 1, wherein the method for provisioning machine learning model resources further comprises:
causing operation of the machine learning model with the provisioned resources.

10. One or more storage devices collectively storing a machine learning model resource provisioning data structure, the data structure comprising:
information specifying a machine learning model;
information specifying one or more resource constraints; and
information specifying two or more resources available for operation of the machine learning model,
such that the information specifying the one or more resource constraints and the information specifying the two or more resources are usable to determine which resources of the two or more resources are to be provisioned for operation of the machine learning model.

11. The one or more storage devices of claim 10, wherein the data structure further comprises:
information specifying a plurality of model containers, each model container including at least a portion of the machine learning model,
such that the information specifying the plurality of model containers is usable to cause the determined resources to be provisioned for operation of the machine learning model.

12. The one or more storage devices of claim 10, wherein the information specifying the machine learning model further comprises:
information specifying a plurality of instances of the model, each instance of the model being optimized for operation using a set of resources.

13. A system for provisioning machine learning model resources, the system comprising:
a computing device configured to:
receive an indication of a machine learning model;
receive an indication of one or more resource constraints;
receive an indication of two or more resources available for operation of the machine learning model; and
determine which resources of the two or more resources are to be provisioned for operation of the machine learning model based on the one or more resource constraints and the indication of two or more resources.

14. The system of claim 13, wherein the computing device is further configured to:
automatically cause the determined resources to be provisioned for operation of the machine learning model.

15. The system of claim 14, wherein the computing device is further configured to:
determine whether the machine learning model is optimized for operation with at least a portion of the determined resources; and
based on the determining, optimize the machine learning model for operation on the portion of the determined resources.

16. The system of claim 14, wherein the computing device is further configured to:
receive an indication that at least a portion of the two or more resources available for operation of the machine learning model have changed;
determine which new resources of the two or more resources are to be provisioned for operation of the machine learning model based on the one or more resources constraints and the two or more resources; and
cause the new resources to be provisioned for operation of the machine learning model.

17. The system of claim 16, wherein the computing device is further configured to:
optimize the machine learning model for operation with the new resources.

18. The system of claim 16, wherein the indication that at least a portion of the two or more resources have changed includes one or more of:
an indication that at least a portion of the one or more resource constraints have changed;
an indication that software used to determine which resources are to be provisioned for operation of the machine learning model have changed; and
an indication that at least one aspect of the two or more resources available for operation of the machine learning model have changed.

19. The system of claim 14, wherein the computing device is further configured to:
for each respective resource of the two or more resources:
determine whether inputs to the machine learning model can be batched while the respective resource is being used for operation of the machine learning model based on the machine learning model, the respective resource, and the resource constraints; and
determine which resources of the two or more resources are to be provisioned for operation of the machine learning model based on the one or more resource constraints, the indication of two or more resources, and the determinations of whether inputs to the machine learning model can be batched.

20. The system of claim 14, wherein the system further comprises:
a plurality of nodes, each node including at least a portion of the determined resources; and
the computing device is further caused to:
generate a plurality of model containers based on the determined resources and the plurality of nodes, each model container including at least a portion of the machine learning model; and
for each respective node of the plurality of nodes:
cause at least one model container of the plurality of model containers to be deployed to the respective node.

21. The system of claim 20, wherein the computing device is further caused to:
for each respective resource of the two or more resources:
determine whether the extent to which the operation of the machine learning model utilizes the respective resource based on the machine learning model and the resource constraints; and
based on the determined extent to which the machine learning model utilizes the respective resource, determine whether the multiple model containers are able to use the respective resource at the same time; and
determine which resources of the two or more resources are to be provisioned for operation of the machine learning model based on the one or more resource constraints, the indication of two or more resources, and the determinations of whether multiple model containers are able to use each resource of the two or more resources.
